(19) United States
(12) Patent Application Publication
(10) Pub. No.: US 2021/0010925 A1
(43) Pub. Date: Jan. 14, 2021

(54) FLOW CYTOMETER AND PARTICLE DETECTION METHOD

(71) Applicant: SYSMEX CORPORATION, Kobe-shi (JP)

(72) Inventors: Tomoya HAYASHI, Kobe-shi (JP); Shohei MATSUMOTO, Kobe-shi (JP); Kazuhiro YAMADA, Kobe-shi (JP)

(73) Assignee: SYSMEX CORPORATION, Kobe-shi (JP)

(21) Appl. No.: 17/035,968

(22) Filed: Sep. 29, 2020

Related U.S. Application Data
(63) Continuation of application No. PCT/JP2019/005589, filed on Feb. 15, 2019.

(30) Foreign Application Priority Data
Mar. 30, 2018 (JP) 2018-067098

(51) Int. Cl. G01N 15/14

(52) U.S. Cl. CPC G01N 15/1459; G01N 2015/1481; G01N 15/1434

(57) ABSTRACT

A flow cytometer, in which detection of light generated from a particle is less likely to be affected by change in a flow velocity of a liquid flowing in a flow cell, is provided. The flow cytometer includes: a flow cell (10) in which a liquid flows; a liquid sending unit (40) configured to send the liquid into the flow cell (10); a controller (300) configured to obtain information related to a flow velocity of the liquid flowing in the flow cell (10); a light source (121) configured to irradiate the liquid flowing in the flow cell (10) with light; and a detector (162) configured to detect light generated from a particle in the liquid irradiated with light. The controller (300) changes a liquid sending condition for the liquid sending unit (40), based on the obtained information related to the flow velocity.

### CROSS REFERENCE TO RELATED APPLICATIONS

This application is a continuation of International Application PCT/JP2019/005589 filed on Feb. 15, 2019, which claims benefit of Japanese patent application JP 2018-067098 filed on Mar. 30, 2018, both of which are incorporated herein by reference in their entireties.

### BACKGROUND OF THE INVENTION

### Field of the Invention

The present invention relates to a flow cytometer and a particle detection method.

### Description of the Background Art

A flow cytometer is widely used for analysis of a biological sample liquid containing particles such as cells, microorganisms, etc. In the flow cytometer, light generated from particles in the biological sample liquid flowing in a transparent flow cell, is detected. Inside the flow cell, a flow of a sample liquid such as the biological sample liquid and a flow of a sheath liquid form a laminar flow. The particles in the sample liquid can be optically analyzed one by one by causing the particles to flow one by one into the flow cell.

U.S. Pat. No. 6,507,391 discloses: irradiating a particle inside a flow cell with light; modulating light generated from the particle by use of an optical grating; and calculating a flow velocity of the particle that flows in the flow cell, based on a detection cycle of modulated light. An image of the particle is captured with the calculated flow velocity of the particle being synchronized with a charge transfer timing of a charge coupled device (CCD) array, whereby a bright image of the particle having a high SN ratio can be obtained.

When optically detecting a particle that flows in a flow cell, a time during which the particle passes across light applied toward the flow cell corresponds to an exposure time. Therefore, when the velocity of the particle flowing in the flow cell is higher, the intensity of the light generated from the particle becomes lower and a signal obtained from a detector that detects the light generated from the particle also becomes weaker. Meanwhile, when the velocity of the particle flowing in the flow cell is lower, the intensity of the light generated from the particle becomes higher and the signal obtained from the detector that detects the light generated from the particle also becomes stronger. Thus, in the flow cytometer, the intensity of the signal obtained from the detector is affected by the flow velocity of the particle.

However, if the intensity of the signal obtained from the detector varies for each of particles to be measured, such variation will adversely affect analysis of the particles and therefore is not desirable. For example, in a flow cytometer that captures an image of a particle according to TDI (Time Delay Integration), since the brightness of the captured image varies according to the flow velocity, it is difficult to obtain an image having a constant brightness for each particle. According to findings of the inventors of the present invention, the flow velocity of a liquid flowing in a flow cell is affected by the ambient temperature, apparatus temperature, liquid temperature, liquid viscosity, change in the liquid level of the liquid in a supply chamber, etc. For example, when the temperature around the flow cell is increased from 15° C. to 30° C., the viscosity of the liquid flowing in the flow cell is lowered, and the flow velocity of the liquid flowing in the flow cell may sometimes be increased from about 2 μL/sec to about 7 μL/sec.

### SUMMARY OF THE INVENTION

An object of the present invention is to provide a flow cytometer and a particle detection method in which detection of light generated from a particle is less likely to be affected by change in the flow velocity of a liquid flowing in a flow cell.

A flow cytometer according to an aspect of the present invention includes: a flow cell in which a liquid flows; a liquid sending unit configured to send the liquid into the flow cell; a controller configured to obtain information related to a flow velocity of the liquid flowing in the flow cell; a light source configured to irradiate the liquid flowing in the flow cell with light; and a detector configured to detect light generated from a particle in the liquid irradiated with light. The controller changes a liquid sending condition for the liquid sending unit, based on the obtained information related to the flow velocity.

According to the above flow cytometer, the controller changes the liquid sending condition for the liquid sending unit, based on the information related to the flow velocity, whereby it is possible to reduce influence of change in the flow velocity on particle detection.

In the above flow cytometer, the controller may further changes a detection condition for the detector, based on the obtained information related to the flow velocity.

According to the above flow cytometer, the controller changes the detection condition for the detector, based on the information related to the flow velocity, whereby it is possible to reduce influence of change in the flow velocity on particle detection.

In the above flow cytometer, the controller may selectively changes the liquid sending condition for the liquid sending unit or the detection condition for the detector, based on the obtained information related to the flow velocity.

According to the above flow cytometer, the liquid sending condition for the liquid sending unit or the detection condition for the detector is selectively changed based on the information related to the flow velocity, whereby it is possible to reduce influence of change in the flow velocity on particle detection.

In the above flow cytometer, the controller may change the liquid sending condition for the liquid sending unit when a difference between a measurement value of the obtained flow velocity and a reference value of a flow velocity is greater than a predetermined value, and may change the detection condition for the detector when the difference between the measurement value of the obtained flow velocity and the reference value of the flow velocity is smaller than the predetermined value.

According to the above flow cytometer, when the difference between the measurement value of the flow velocity and the reference value of the flow velocity is great, the liquid sending condition for the liquid sending unit is changed to change the flow velocity, whereby the flow velocity can be approximated to the reference value. Meanwhile, when the difference between the measurement value of the flow velocity and the reference value of the flow velocity is too small to be reduced by changing the liquid sending condition, influence of the difference in flow velocity on particle detection can be reduced by changing the detection condition for the detector.

In the above flow cytometer, the controller may cause the liquid sending unit to reduce an amount of the liquid to be sent into the flow cell when the measurement value of the obtained flow velocity is greater than the reference value of the flow velocity and the difference is greater than the predetermined value, and may cause the liquid sending unit to increase the amount of the liquid to be sent into the flow cell when the measurement value of the obtained flow velocity is smaller than the reference value of the flow velocity and the difference is greater than the predetermined value.

According to the above flow cytometer, the amount of the liquid to be sent to the flow cell by the liquid sending unit is changed based on feedback of the difference between the measurement value of the flow velocity and the reference value of the flow velocity, whereby the flow velocity can be approximated to the reference value.

In the above flow cytometer, the detector may include a photoelectric converter configured to perform photoelectric conversion of the light generated from the particle flowing in the flow cell. The controller may further change sensitivity of the detector, based on the obtained information related to the flow velocity. The controller may increase the sensitivity of the detector when the measurement value of the obtained flow velocity is greater than the reference value of the flow velocity and the difference is smaller than the predetermined value, and may reduce the sensitivity of the detector when the measurement value of the obtained flow velocity is smaller than the reference value of the flow velocity and the difference is smaller than the predetermined value.

According to the above flow cytometer, the sensitivity of the detector is changed based on feedback of the difference between the measurement value of the flow velocity and the reference value of the flow velocity, whereby it is possible to reduce variation in the intensity of a signal obtained from the detector for detecting light generated from the particle.

The above flow cytometer may further include a lens configured to condense the light generated from the particle in the liquid irradiated with light. The controller may further change magnification of an image, of the particle, formed by the lens, based on the obtained information related to the flow velocity. The controller may reduce the magnification of the image of the particle formed by the lens, when the measurement value of the obtained flow velocity is greater than the reference value of the flow velocity and the difference is smaller than the predetermined value, and may increase the magnification of the image of the particle formed by the lens when the measurement value of the obtained flow velocity is smaller than the reference value of the flow velocity and the difference is smaller than the predetermined value.

According to the above flow cytometer, the magnification of the image of the particle is changed based on feedback of the difference between the measurement value of the flow velocity and the reference value of the flow velocity, whereby it is possible to reduce variation in the light intensity of the image of the particle.

In the above flow cytometer, the controller may further change the intensity of light emitted from the light source, based on the obtained information related to the flow velocity. The controller may increase the intensity of light emitted from the light source when the measurement value of the obtained flow velocity is greater than the reference value of the flow velocity, and may reduce the intensity of light emitted from the light source when the measurement value of the obtained flow velocity is smaller than the reference value of the flow velocity and the difference is smaller than the predetermined value.

According to the above flow cytometer, the intensity of light emitted from the light source is changed based on feedback of the difference between the measurement value of the flow velocity and the reference value of the flow velocity, whereby it is possible to reduce variation in the intensity of light generated from the particle.

In the above flow cytometer, the detector may capture an image of the particle flowing in the flow cell. The detector may capture the image of the particle flowing in the flow cell, according to TDI (Time Delay Integration). The detector may set a scanning rate, based on the obtained information related to the flow velocity.

According to the above flow cytometer, for example, when the particle is a cell in which a specific gene locus in a chromosome is fluorescence-labeled, it is possible to reduce influence of change in the flow velocity on the brightness of the fluorescence image of the cell.

In the above flow cytometer, the controller may calculate the information related to the flow velocity, based on an optical property of the particle flowing in the flow cell.

According to the above flow cytometer, the flow velocity of the liquid flowing in the flow cell can be accurately calculated.

A flow cytometer according to an aspect of the present invention includes: a flow cell in which a liquid flows; a liquid sending unit configured to send the liquid into the flow cell; a controller configured to obtain information related to a flow velocity of the liquid flowing in the flow cell; a light source configured to irradiate the liquid flowing in the flow cell with light; and a detector configured to detect light generated from the particle in the liquid irradiated with light. The controller changes sensitivity of the detector, based on the obtained information related to the flow velocity. The controller changes sensitivity of the detector, based on the obtained information related to the flow velocity.

According to the above flow cytometer, the controller changes the sensitivity of the detector, based on the information related to the flow velocity, whereby it is possible to reduce influence of change in the flow velocity on particle detection.

A flow cytometer according to an aspect of the present invention includes: a flow cell in which a liquid flows; a liquid sending unit configured to send the liquid into the flow cell; a controller configured to obtain information related to a flow velocity of the liquid flowing in the flow cell; a light source configured to irradiate the liquid flowing in the flow cell with light; and a detector configured to detect light generated from the particle in the liquid irradiated with light. The controller changes an intensity of light emitted from the light source, based on the obtained information related to the flow velocity.

According to the above flow cytometer, the intensity of light emitted from the light source is changed based on the information related to the flow velocity, whereby it is possible to reduce influence of change in the flow velocity on particle detection.

A particle detection method according to an aspect of the present invention includes: sending a liquid into a flow cell; obtaining information related to a flow velocity of the liquid flowing in the flow cell; changing a liquid sending condition for sending the liquid into the flow cell, based on the obtained information related to the flow velocity; irradiating the liquid flowing in the flow cell with light; and detecting light generated from a particle in the liquid irradiated with light.

According to the above particle detection method, the liquid sending condition for sending the liquid into the flow cell is changed based on the information related to the flow velocity, whereby it is possible to reduce influence of change in the flow velocity on particle detection.

In the above particle detection method, a detection condition for detecting the light generated from the particle may be changed based on the obtained information related to the flow velocity.

According to the above particle detection method, the detection condition for detecting light generated from the particle is changed based on the information related to the flow velocity, whereby it is possible to reduce influence of change in the flow velocity on particle detection.

In the above particle detection method, the liquid sending condition or the detection condition may be selectively changed based on the obtained information related to the flow velocity.

According to the above particle detection method, the liquid sending condition or the detection condition is selectively changed based on the information related to the flow velocity, whereby it is possible to reduce influence of change in the flow velocity on particle detection.

In the above particle detection method, the liquid sending condition may be changed when a difference between a measurement value of the obtained flow velocity and a reference value of a flow velocity is greater than a predetermined value, and the detection condition may be changed when the difference between the measurement value of the obtained flow velocity and the reference value of the flow velocity is smaller than the predetermined value.

According to the above particle detection method, when the difference between the measurement value of the flow velocity and the reference value of the flow velocity is great, the liquid sending condition for the liquid sending unit is changed to change the flow velocity, whereby the flow velocity can be approximated to the reference value. Meanwhile, when the difference between the measurement value of the flow velocity and the reference value of the flow velocity is too small to be reduced by changing the liquid sending condition for sending the liquid into the flow cell, influence of the difference in flow velocity on particle detection can be reduced by changing the detection condition for the detector.

In the above particle detection method, the amount of the liquid to be sent into the flow cell may be reduced when the measurement value of the obtained flow velocity is greater than the reference value of the flow velocity and the difference is greater than the predetermined value, and the amount of the liquid to be sent into the flow cell may be increased when the measurement value of the obtained flow velocity is smaller than the reference value of the flow velocity and the difference is greater than the predetermined value.

According to the above particle detection method, the amount of the liquid to be sent to the flow cell is changed based on feedback of the difference between the measurement value of the flow velocity and the reference value of the flow velocity, whereby the flow velocity can be approximated to the reference value.

In the above particle detection method, the light generated from the particle in the liquid may be subjected to photoelectric conversion by a photoelectric converter. Sensitivity of a detector for detecting the light generated from the particle in the liquid may be changed based on the obtained information related to the flow velocity. The sensitivity of the detector for detecting the light may be increased when the measurement value of the obtained flow velocity is greater than the reference value of the flow velocity and the difference is smaller than the predetermined value, and the sensitivity of the detector may be reduced when the measurement value of the flow velocity is smaller than the reference value of the flow velocity and the difference is smaller than the predetermined value.

According to the above particle detection method, the sensitivity of the detector is changed based on feedback of the difference between the measurement value of the flow velocity and the reference value of the flow velocity, whereby it is possible to reduce variation in the intensity of a signal obtained from the detector for detecting light generated from the particle.

In the above particle detection method, the light generated from the particle in the liquid irradiated with light may be condensed by a lens. Magnification of an image, of the particle, formed by the lens may be changed based on the obtained information related to the flow velocity. The magnification of the image of the particle formed by the lens may be reduced when the measurement value of the obtained flow velocity is greater than the reference value of the flow velocity and the difference is smaller than the predetermined value, and the magnification of the image of the particle formed by the lens may be increased when the measurement value of the obtained flow velocity is smaller than the reference value of the flow velocity and the difference is smaller than the predetermined value.

According to the above particle detection method, the magnification of the image of the particle is changed based on feedback of the difference between the measurement value of the flow velocity and the reference value of the flow velocity, whereby it is possible to reduce variation in the light intensity of the image of the particle.

In the above particle detection method, the intensity of light applied to the inside of the flow cell may be changed based on the obtained information related to the flow velocity. The intensity of light applied to the inside of the flow cell may be increased when the measurement value of the flow velocity is greater than the reference value of the flow velocity and the difference is smaller than the predetermined value, and the intensity of light applied to the inside of the flow cell may be reduced when the measurement value of the flow velocity is smaller than the reference value of the flow velocity and the difference is smaller than the predetermined value.

According to the above particle detection method, the intensity of light applied to the flow cell is changed based on feedback of the difference between the measurement value of the flow velocity and the reference value of the flow velocity, whereby it is possible to reduce variation in the intensity of light generated from the particle.

In the above particle detection method, detecting the light generated from the particle may include capturing an image of the particle flowing in the flow cell. The image of the particle flowing in the flow cell may be captured according to TDI (Time Delay Integration). A scanning rate of a detector for detecting the light generated from the particle in the liquid may be set based on the obtained information related to the flow velocity.

According to the above particle detection method, for example, when the particle is a cell in which a specific gene locus in a chromosome is fluorescence-labeled, it is possible to reduce influence of change in the flow velocity on the brightness of the fluorescence image of the cell.

In the above particle detection method, the information related to the flow velocity may be calculated based on an optical property of the particle flowing in the flow cell.

According to the above particle detection method, the flow velocity of the liquid flowing in the flow cell can be accurately calculated.

A particle detection method according to an aspect of the present invention includes: sending a liquid into a flow cell; obtaining information related to a flow velocity of the liquid flowing in the flow cell; irradiating the liquid flowing in the flow cell with light; detecting light generated from the particle in the liquid irradiated with light; and changing sensitivity of a detector for detecting the light generated from the particle in the liquid, based on the obtained information related to the flow velocity.

According to the above particle detection method, the sensitivity of the detector is changed based on the information related to the flow velocity, whereby it is possible to reduce influence of change in the flow velocity on particle detection.

A particle detection method according to an aspect of the present invention includes: sending a liquid into a flow cell; obtaining information related to a flow velocity of the liquid flowing in the flow cell; irradiating the liquid flowing in the flow cell with light; detecting light generated from the particle in the liquid irradiated with light; and changing an intensity of light applied to the inside of the flow cell, based on the obtained information related to the flow velocity.

According to the above particle detection method, the intensity of light applied to the inside of the flow cell is changed based on the information related to the flow velocity, whereby it is possible to reduce influence of change in the flow velocity on particle detection.

According to the present invention, it is possible to provide a flow cytometer and a particle detection method in which detection of light generated from a particle is less likely to be affected by change in the flow velocity of a liquid flowing inside a flow cell.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram showing a flow path, an optical system, and the like of a flow cytometer according to an embodiment;

FIG. 2 is a schematic diagram showing the optical system and the like of the flow cytometer according to the embodiment;

FIG. 3 is a schematic diagram showing an optical grating according to the embodiment;

FIG. 4 is a graph schematically showing a relationship between the flow velocity of a particle flowing in a flow cell and the brightness of an image of the particle captured;

FIG. 5 is a schematic diagram showing the flow path and the like of the flow cytometer according to the embodiment;

FIG. 6 is a schematic diagram showing the flow path and the like of the flow cytometer according to the embodiment;

FIG. 7 is a flowchart showing a particle detection method according to the embodiment;

FIG. 8 shows a continuation of the flowchart showing the particle detection method according to the embodiment; and

FIG. 9 shows a continuation of the flowchart showing the particle detection method according to the embodiment.

### DESCRIPTION OF THE PREFERRED EMBODIMENTS

Hereinafter, an embodiment of the present invention will be described with reference to the drawings. In the following description related to the drawings, the same or similar components are designated by the same or similar reference numerals. However, the drawings are schematic. Therefore, specific dimensions and the like should be determined in light of the following description. It is a matter of course that portions having different dimensional relationships and ratios are included between the drawings.

In the following embodiment, the present invention is applied to fluorescence detection in fluorescence in situ hybridization (FISH). In a pretreatment for FISH, a probe is hybridized with a target sequence present in a chromosome of a cell. The probe contains a nucleic acid sequence complementary to the target sequence, and is labeled with a fluorescent dye. The chromosome may be treated by a plurality of probes labeled with different fluorescent dyes for respective target sequences. For example, if translocation of a gene containing a target sequence occurs in a chromosome, the position at which a bright point of fluorescence is observed on the chromosome is shifted from the normal position. Therefore, the translocation can be detected by FISH. Furthermore, according to FISH, not only translocation but also chromosome abnormalities such as deletion, inversion, and duplication can be detected.

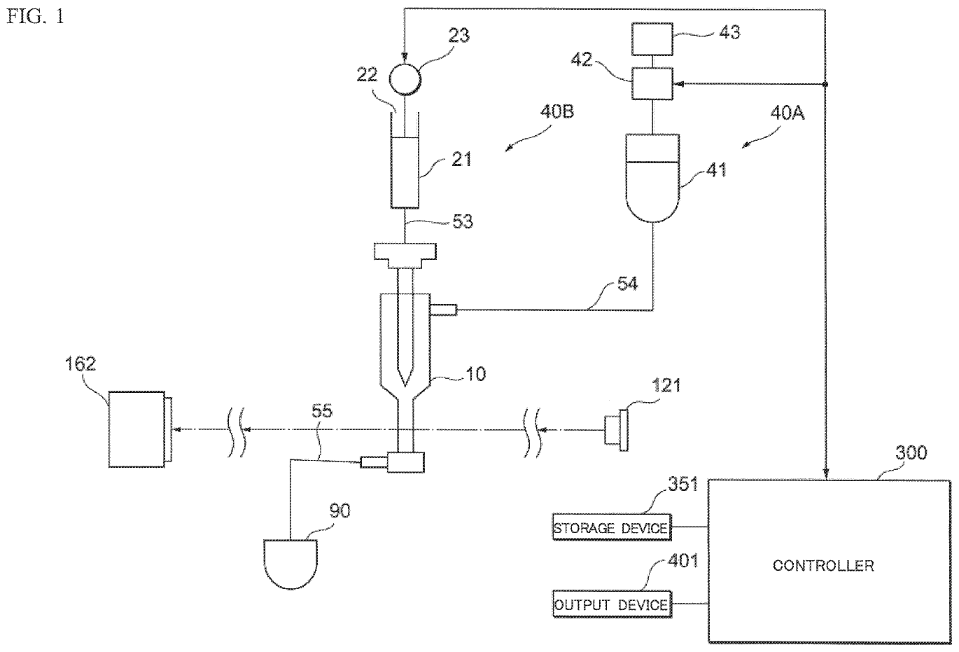

As shown in FIG. 1, a flow cytometer according to the embodiment includes: a flow cell 10 in which a liquid flows; a liquid sending unit 40 that sends the liquid into the flow cell 10; a controller 300 that obtains information related to the flow velocity of the liquid flowing in the flow cell 10; a light source 121 that irradiates the liquid flowing in the flow cell 10 with light; and a detector 162 that detects a particle in the liquid irradiated with light. In the flow cytometer according to the embodiment, the controller 300 changes a liquid sending condition for the liquid sending unit 40, based on the information related to the flow velocity. The controller 300 is implemented by a central processing unit (CPU).

The liquid sending unit 40 includes: a sheath liquid sending unit 40A that sends a sheath liquid to the flow cell 10; and a sample liquid sending unit 40B that sends a sample liquid containing particles to the flow cell 10.

The sheath liquid sending unit 40A includes: a chamber 41 that stores the sheath liquid therein; an electropneumatic converter 42 that receives an electric control signal and applies an air pressure to the chamber 41; and a compressor 43 that is a source of the air pressure of the electropneumatic converter 42. The electropneumatic converter 42 is an element capable of adjusting an air pressure to be discharged, based on an inputted electric signal (current or voltage). When an air pressure is applied into the chamber 41, the sheath liquid in the chamber 41 is sent to the flow cell 10 through a sheath liquid flow path 54. The sheath liquid sending unit 40A may be a syringe pump or a diaphragm pump.

The sample liquid sending unit 40B includes, for example, a syringe 21, an operating element 22 such as a plunger or a piston inserted in the syringe 21, and a driving device 23 such as a motor that moves the operating element 22. When the driving device 23 presses the operating element 22, the sample liquid is sent to the flow cell 10 through a sample liquid flow path 53. The sample liquid sending unit 40B may be a diaphragm pump.

Alternatively, the sample liquid sending unit 40B may send the sample liquid by using an air pressure that is generated by an electropneumatic converter connected to a pressure source such as a compressor.

The sheath liquid sending unit 40A may send the sheath liquid also to the sample liquid sending unit 40B to balance the pressure of the sheath liquid and the pressure of the sample liquid in the flow cell 10.

A particle contained in the sample liquid is either a sample particle whose characteristics are to be analyzed by the flow cytometer or a reference particle for monitoring the flow velocity of a particle flowing in the flow cell 10. In the present embodiment, the sample particle is a cell treated by a plurality of probes. The reference particle is a particle different from the sample particle. The reference particle is, for example, a non-biological particle, and is composed of a polymer such as latex, or an inorganic substance. The reference particle has an optical property such that it generates scattered light having a higher intensity than the sample particle, when irradiated with light. A sample liquid containing both the sample particle and the reference particle may be supplied to the flow cell 10. Alternatively, a sample liquid containing the sample particle and a sample liquid containing the reference particle may be separately supplied to the flow cell 10.

The flow cell 10 is formed of a transparent material such as quartz. Inside the flow cell 10, a flow of the sample liquid and a flow of the sheath liquid form a laminar flow, and the sample liquid flows so as to be surrounded by the flow of the sheath liquid. The sample liquid and the sheath liquid, having flowed in the flow cell 10, pass through a waste liquid flow path 55 and are discharged from an end portion of the waste liquid flow path 55 into a waste liquid chamber 90. For example, the end portion of the waste liquid flow path 55 is exposed to the air.

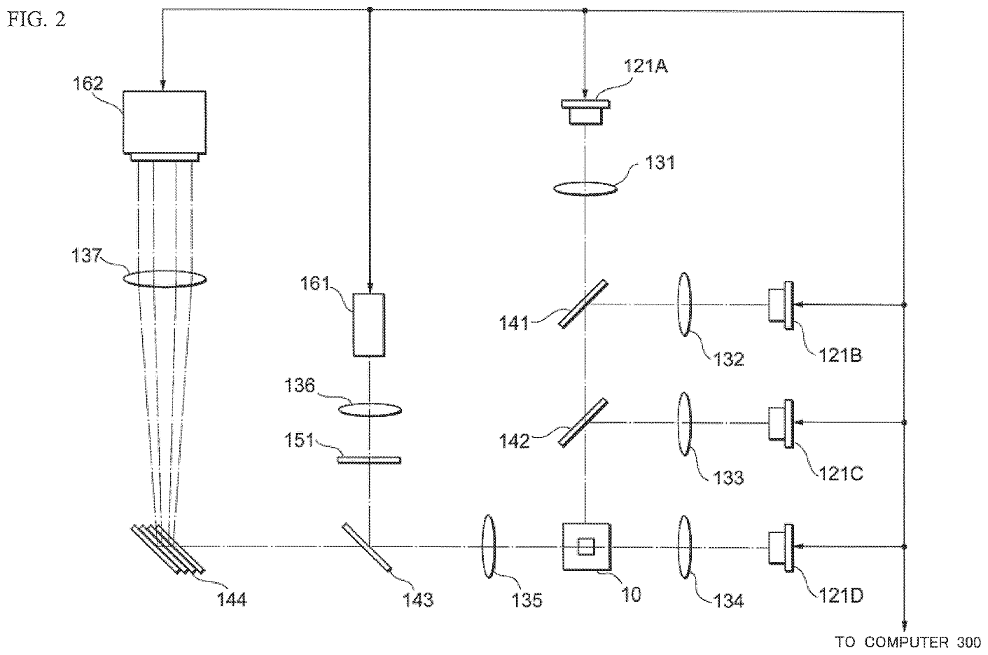

As shown in FIG. 2, the flow cytometer according to the embodiment is provided with an optical system capable of measuring the flow velocity of a particle, based on the optical property of the reference particle flowing in the flow cell 10. In FIG. 2, the flow cell 10 is indicated by a cross section. The optical system capable of measuring the flow velocity of the reference particle flowing in the flow cell 10 is provided with a light source 121A that applies light to the flow cell 10. As the light source 121A, a laser, a light-emitting diode, or the like can be used. For example, the light emitted from the light source 121A is condensed by a lens 131, is transmitted through dichroic mirrors 141, 142, and is condensed onto the flow cell 10. In a case where the reference particle flowing in the flow cell 10 has an optical property such that it generates Mie-scattered light as reaction light when irradiated with light, scattered light having the same wavelength as the light emitted from the light source 121A is generated from the particle. The scattered light is condensed by a lens 135 and is reflected by a dichroic mirror 143.

An optical grating 151 is disposed on an optical path of the scattered light having been reflected by the dichroic mirror 143. As shown in FIG. 3, the optical grating 151 includes a plurality of transparent portions 152a, 152b, 152c, . . . , and a plurality of opaque portions 153a, 153b, 153c, . . . , which are alternatively disposed. The plurality of transparent portions 152a, . . . , and the plurality of opaque portions 153a, . . . , each have a rectangular shape, for example. The pitch of the optical grating 151 is constant. The plurality of transparent portions 152a, . . . , and the plurality of opaque portions 153a, . . . , each have a width approximated to the size of the reference particle that flows in the flow cell 10 shown in FIG. 2, for example.

When the reference particle passes across the light emitted from the light source 121A in the flow cell 10, scattered light generated from the reference particle alternately passes through the plurality of transparent portions 152a, . . . , and the plurality of opaque portions 153a, . . . , of the optical grating 151 shown in FIG. 3. Therefore, the intensity of the scattered light is modulated by the optical grating 151. The modulated light, of the scattered light, generated by the optical grating 151 is condensed by a lens 136 shown in FIG. 2, and is detected by a flow velocity detector 161. As the flow velocity detector 161, an optical detector including a photoelectric converter such as a photomultiplier tube or a photodiode can be used.

The cycle with which the flow velocity detector 161 detects the modulated light is proportional to the flow velocity of the particle flowing in the flow cell 10. The flow velocity detector 161 is connected to the controller 300 shown in FIG. 1. For example, the controller 300 specifies a cycle f according to fast Fourier transform (FFT), and calculates, as a value related to a flow velocity, a measurement value of a flow velocity v of the particle flowing in the flow cell 10, based on the following equation (1).

v=fp (1)

In equation (1), p indicates the pitch of the optical grating 151. The value of the flow velocity may be an average value. The average value may be calculated by moving average.

The configuration of the equipment for measuring the flow velocity is not limited to the above-described one. For example, it is assumed that an already-known beam diameter, in the flow cell 10, of the light applied to the flow cell 10 is D_{B}, an already-known diameter of the reference particle is D_{S}, and a pulse width of a fluorescence that occurs when the reference particle passes across the beam diameter is P_{W}. Then, the flow velocity v of the particle flowing in the flow cell 10 may be calculated based on the following equation (2).

v=(D_{B}+D_{S})/P_{W} (2)

In this case, the optical grating 151 is not necessary, and the controller 300 may calculate the flow velocity v, based on the pulse width of the reaction light detected by the flow velocity detector 161.

Meanwhile, the equipment for measuring the flow velocity may be provided with two particle detectors. In this case, the controller 300 may calculate the flow velocity v of the particle, based on an already-known distance between the two particle detectors, and on a time from when a reference particle is detected by the upstream-side particle detector to when the reference particle is detected by the downstream-side particle detector. Alternatively, the equipment for measuring the flow velocity may be provided with a flowmeter disposed on a flow path connected to the outlet side of the flow cell 10. In this case, the controller 300 may calculate the flow velocity v of the particle, based on a flow rate measured by the flowmeter, a difference between the opening diameter of the flow cell 10 and the opening diameter of the flow path, and the like.

As shown in FIG. 2, the flow cytometer according to the embodiment is provided with the optical system capable of capturing an image of a cell that flows in the flow cell 10. The optical system capable of capturing an image of a cell that flows in the flow cell 10 further includes light sources 121B, 121C, and 121D in addition to the light source 121A.

The light source 121A emits light having a wavelength λ_{E1}. The light source 121A can adjust the intensity of the light emitted. In a case where a target sequence in a cell is labeled with a fluorescent dye that is excited by the light of the wavelength λ_{E1} emitted from the light source 121A, a fluorescence having a wavelength λ_{F1} is emitted from a gene locus including the target sequence of the cell that flows in the flow cell 10. The wavelength λ_{F1} is the wavelength of green, for example.

The light source 121B emits light having a wavelength λ_{E2} different from the wavelength λ_{E1}. The light source 121B can adjust the intensity of the light emitted. For example, the light emitted from the light source 121B is condensed by a lens 132, is reflected toward the flow cell 10 by the dichroic mirror 141, is transmitted through a dichroic mirror 142, and reaches the flow cell 10. In a case where a target sequence in a cell is labeled with a fluorescent dye that is excited by the light of the wavelength λ_{E2} emitted from the light source 121B, a fluorescence having a wavelength λ_{F2} is emitted from a gene locus including the target sequence of the cell that flows in the flow cell 10. The wavelength λ_{F2} is the wavelength of red, for example.

The light source 121C emits light having a wavelength 43 different from the wavelengths λ_{E1} and λ_{E2}. The light source 121C can adjust the intensity of the light emitted. For example, the light emitted from the light source 121C is condensed by a lens 133, is reflected toward the flow cell 10 by the dichroic mirror 142, and reaches the flow cell 10. In a case where a target sequence in a cell is labeled with a fluorescent dye that is excited by the light of the wavelength λ_{E3} emitted from the light source 121C, a fluorescence having a wavelength λ_{F3} is emitted from a gene locus including the target sequence of the cell that flows in the flow cell 10. The wavelength λ_{F3} is the wavelength of blue, for example.

The light source 121D emits light having a wavelength λ_{E4} different from the wavelengths λ_{E1} to λ_{E3}. The light source 121D can adjust the intensity of the light emitted. The light of the wavelength λ_{E4} is visible light, for example. For example, the light emitted from the light source 121D is condensed by a lens 134, and reaches the flow cell 10. The light of the wavelength λ_{E4} is transmitted through a particle in the flow cell 10. Therefore, transmitted light of the wavelength λ_{E4} is generated from the particle.

The fluorescences of the wavelengths λ_{F1} to λ_{F3} and the transmitted light of the wavelength λ_{E4}, which have been generated from the particle in the flow cell 10, pass through a lens 135, are transmitted through the dichroic mirror 143, and reach an optical unit 144. In the optical unit 144, four dichroic mirrors are combined, for example. The four dichroic mirrors reflect the fluorescences of the wavelengths 41 to 43 and the transmitted light of the wavelength λ_{E4} at angles slightly different from each other toward the detector 162. The fluorescences of the wavelengths λ_{F1} to λ_{F3} and the transmitted light of the wavelength λ_{E4}, which have been reflected by the optical unit 144, are condensed by a lens 137, and reach different positions on the light receiving surface of the detector 162. The lens 137 may be selected from among a plurality of lenses for changing magnification of each particle image on the light receiving surface. The detector 162 has, at the light receiving surface, a plurality of photoelectric converters. The respective photoelectric converters convert the fluorescences and the transmitted light into electric signals. The sensitivities of the respective photoelectric converters are adjustable.

For example, the detector 162 is a TDI imaging device, and includes a CCD array as a photoelectric converter array. The detector 162 receives, from the controller 300 shown in FIG. 1, information of the value of the flow velocity of the particle that flows in the flow cell 10. The detector 162 shown in FIG. 2 generates three fluorescence images corresponding to the fluorescences of the wavelengths λ_{F1} to λ_{F3} and a bright field image corresponding to the transmitted light of the wavelength λ_{E4}, with the received value of the flow velocity being synchronized with a scanning rate (charge transfer rate) of the CCD array. The brightness of each fluorescence image is proportional to the intensity of the electric signal obtained through photoelectric conversion from the corresponding fluorescence in the detector 162.

The controller 300 shown in FIG. 1 calculates an absolute value of a difference between the measurement value of the flow velocity of the particle and a reference value of a flow velocity. For example, the reference value of the flow velocity is set based on a flow velocity with which the brightness of the captured fluorescence has an appropriate predetermined value. In this disclosure, “absolute value of a difference” is simply referred to as “difference”. When the difference between the measurement value of the flow velocity of the particle and the reference value of the flow velocity is greater than a predetermined value, the controller 300 changes the liquid sending condition for the liquid sending unit 40. When the difference between the measurement value of the flow velocity of the particle and the reference value of the flow velocity is smaller than the predetermined value, the controller 300 may change the detection condition for the detector 162, may change the light-emitting condition for the light source 121, or may change the magnification condition for the lens 137.

Although the liquid sending unit 40 can significantly change the flow velocity of a cell flowing in the flow cell 10 by changing the liquid sending condition, there are cases where the liquid sending unit 40 is not suitable for minutely changing the flow velocity. Therefore, the predetermined value of a difference in flow velocity is set based on, for example, a minimum value of a variation width of the flow velocity that is variable by the liquid sending unit 40 changing the liquid sending condition.

Although the brightness of the fluorescence image can be minutely changed by changing each of the detection condition for the detector 162, the light-emission condition for the light source 121, the magnification condition for the lens 137, and the like, there are cases where it is difficult to significantly change the detection condition, the light-emission condition, and the magnification condition. Therefore, the predetermined value of a difference in flow velocity may be set based on a maximum value of a variation width of the brightness of the fluorescence image which is variable by changing the detection condition, the light emission condition, or the magnification condition.

Information indicating the reference value of the flow velocity and the predetermined value of a difference in flow velocity is stored in a memory included in the controller 300, or a storage device 351 connected to the controller 300. This information may be changed by an input from a user, for example.

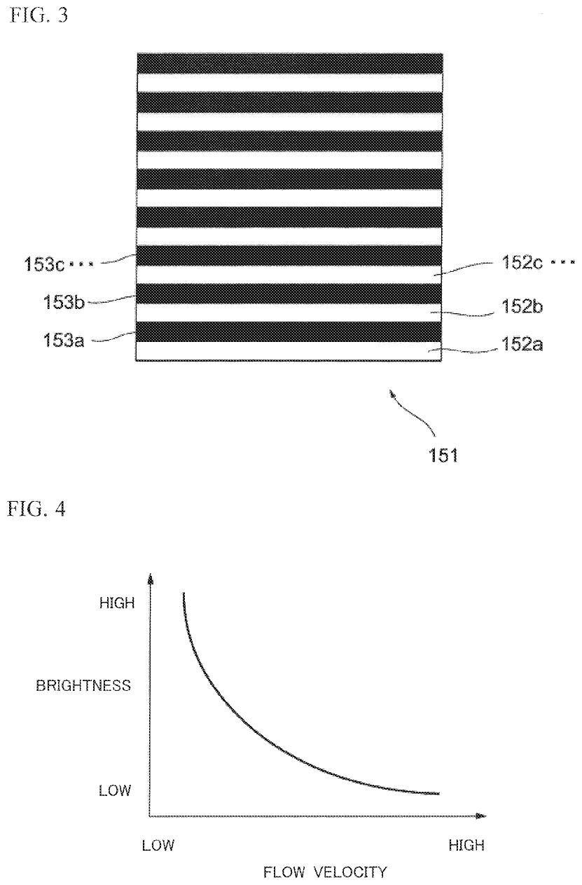

The liquid sending condition for the liquid sending unit 40 is, for example, a liquid amount per unit time when the sheath liquid sending unit 40A sends the sheath liquid to the flow cell 10, or a liquid amount per unit time when the sample liquid sending unit 40B sends the sample liquid to the flow cell 10. Alternatively, the liquid sending condition may be a pressure at which the sheath liquid sending unit 40A sends the sheath liquid to the flow cell 10, or a pressure at which the sample liquid sending unit 40B sends the sample liquid to the flow cell 10. The brightness of the fluorescence image is proportional to the intensity of the electric signal obtained by the detector 162, and the intensity of the electric signal obtained by the detector 162 is inversely proportional to the flow velocity of the liquid flowing in the flow cell 10. Therefore, as shown in FIG. 4, the brightness of the fluorescence image is inversely proportional to the flow velocity of the liquid flowing in the flow cell 10. The flow velocity of the liquid flowing in the flow cell 10 shown in FIG. 1 is proportional to the amount of the liquid sent by the liquid sending unit 40 or a pressure applied to the liquid.

Therefore, for example, when the measurement value of the flow velocity is greater than the reference value of the flow velocity and the difference is greater than the predetermined value, the controller 300 reduces the amount of the sheath liquid to be sent to the flow cell 10 by the sheath liquid sending unit 40A, and the amount of the sample liquid to be sent to the flow cell 10 by the sample liquid sending unit 40B. When the measurement value of the flow velocity is smaller than the reference value of the flow velocity and the difference is greater than the predetermined value, the controller 300 increases the amount of the sheath liquid to be sent to the flow cell 10 by the sheath liquid sending unit 40A, and the amount of the sample liquid to be sent to the flow cell 10 by the sample liquid sending unit 40B. The controller 300, performing the control as described above, approximates the flow velocity of the particle flowing in the flow cell 10 to the reference value, and approximates the brightness of the fluorescence image to the appropriate value, thereby reducing variation in the brightness.

Usually, the flow rate of the sheath liquid is higher than the flow rate of the sample liquid. Therefore, as for influence on the flow velocity of a particle contained in the sample liquid, the feeding amount of the sheath liquid is more dominant than the feeding amount of the sample liquid. Therefore, the controller 300 may change the amount of the sheath liquid to be sent to the flow cell 10 by the sheath liquid sending unit 40A, and may not necessarily change the amount of the sample liquid to be sent to the flow cell 10 by the sample liquid sending unit 40B.

Focus is placed on only the sheath liquid out of the sheath liquid and the sample liquid, and it is assumed that the pressure applied to the sheath liquid in the chamber 41 is constant, and the viscosity of the sheath liquid is constant. Then, the flow velocity v of the sheath liquid is approximated by the following equation (3).

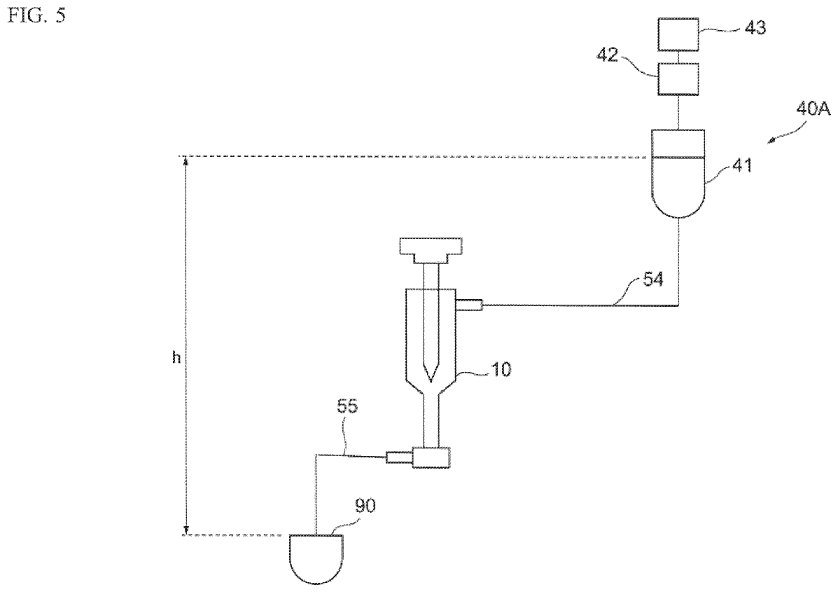

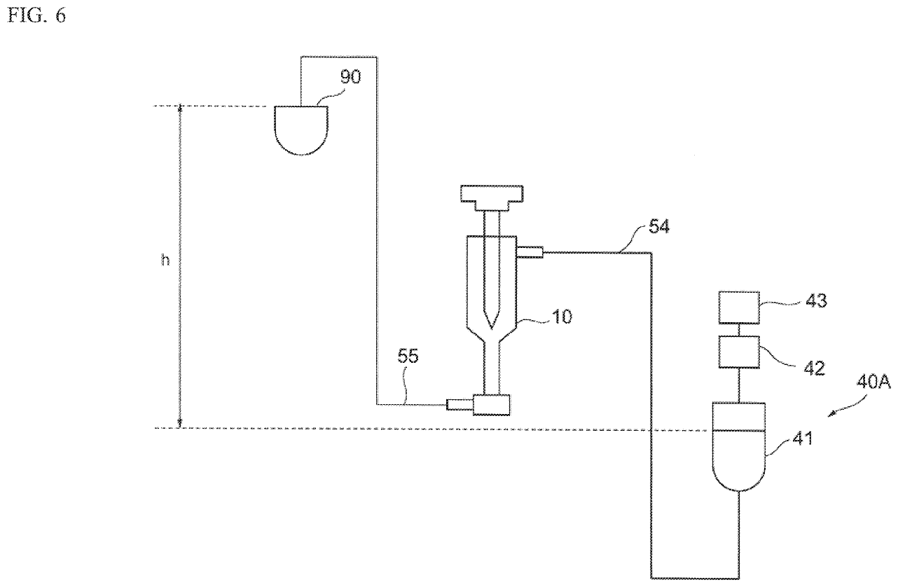

v=(2gh)^{1/2} (3)

where g indicates the acceleration of gravity, and h indicates a difference in height between the liquid level of the sheath liquid in the chamber 41 and the open end of the waste liquid flow path 55 as shown in FIG. 5. Therefore, when the liquid level of the sheath liquid in the chamber 41 is lowered, the difference h in height is decreased in equation (3), whereby the flow velocity v of the sheath liquid is reduced. The same applies to the case where the liquid level of the sheath liquid in the chamber 41 is at a position higher than the open end of the waste liquid flow path 55 as shown in FIG. 5, and to the case where the liquid level of the sheath liquid in the chamber 41 is at a position lower than the open end of the waste liquid flow path 55 as shown in FIG. 6. Although it is assumed that the viscosity of the sheath liquid is constant in equation (3), even when the viscosity of the sheath liquid changes with temperature change or the like, the flow velocity v of the sheath liquid can be changed.

Meanwhile, in the flow cytometer according to the embodiment, the amount of the sheath liquid to be sent to the flow cell 10 by the sheath liquid sending unit 40A and the amount of the sample liquid to be sent to the flow cell 10 by the sample liquid sending unit 40B are feedback-controlled based on the measurement value of the flow velocity that has been calculated. Therefore, even when the liquid level of the sheath liquid in the chamber 41 varies or the viscosity of the sheath liquid changes, the flow velocity of each cell flowing in the flow cell 10 can be approximated to the reference value of the flow velocity, and the brightness of the fluorescence image can be approximated to the appropriate value, whereby variation in the brightness can be reduced.

The detection condition for the detector 162 shown in FIG. 1 is, for example, the sensitivity of the photoelectric converter included in the detector 162. The brightness of the fluorescence image is proportional to the sensitivity of the photoelectric converter. Therefore, for example, when the measurement value of the flow velocity is greater than the reference value of the flow velocity and the difference is smaller than the predetermined value, the controller 300 shown in FIG. 1 increases the sensitivity of the photoelectric converter included in the detector 162. When the measurement value of the flow velocity is smaller than the reference value of the flow velocity and the difference is smaller than the predetermined value, the controller 300 reduces the sensitivity of the photoelectric converter in the detector 162. With this control, the controller 300 approximates the brightness of the fluorescence image to the appropriate value, and reduces variation in the brightness.

The light emission condition for the light source 121 is, for example, the intensity of light emitted from the light source 121. The brightness of the fluorescence image is proportional to the intensity of light emitted from the light source 121. Therefore, for example, when the measurement value of the flow velocity is greater than the reference value of the flow velocity and the difference is smaller than the predetermined value, the controller 300 increases the intensity of light emitted from the light source 121. When the measurement value of the flow velocity is smaller than the reference value of the flow velocity and the difference is smaller than the predetermined value, the controller 300 reduces the intensity of light emitted from the light source 121. With this control, the controller 300 approximates the brightness of the fluorescence image to the appropriate value, and reduces variation in the brightness.

The magnification condition for the lens 137 is, for example, the magnification of a particle image that is formed on the light receiving surface of the detector 162 by the lens 137. The brightness of the fluorescence image is inversely proportional to the magnification of the particle image formed by the lens 137. Therefore, for example, when the measurement value of the flow velocity is greater than the reference value of the flow velocity and the difference is smaller than the predetermined value, the controller 300 replaces the lens 137 to reduce the magnification of the particle image formed by the lens 137. When the measurement value of the flow velocity is smaller than the reference value of the flow velocity and the difference is smaller than the predetermined value, the controller 300 replaces the lens 137 to increase the magnification of the particle image formed by the lens 137. With this control, the controller 300 approximates the brightness of the fluorescence image to the appropriate value, and reduces variation in the brightness.

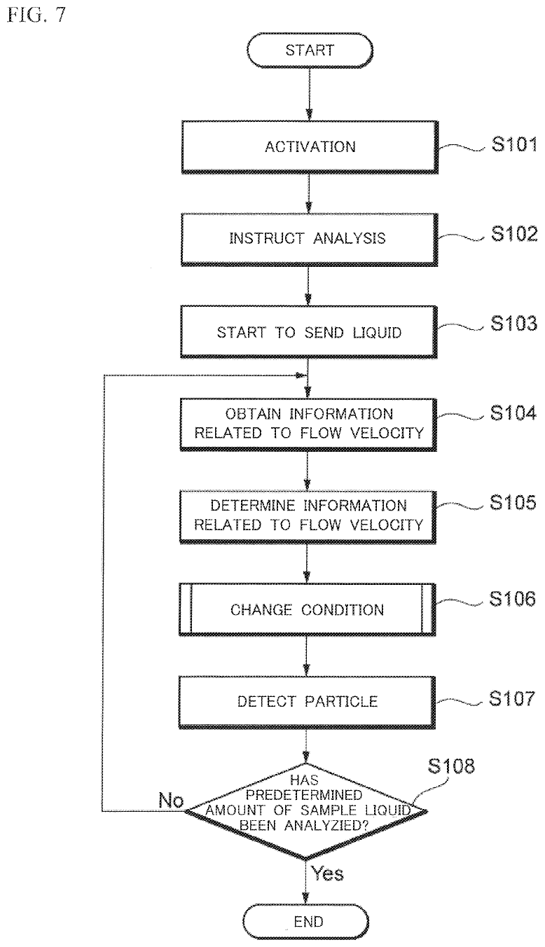

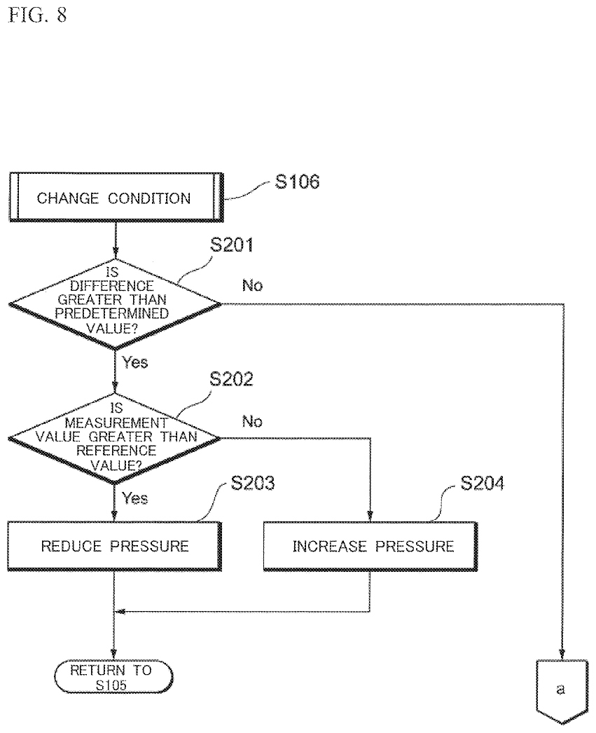

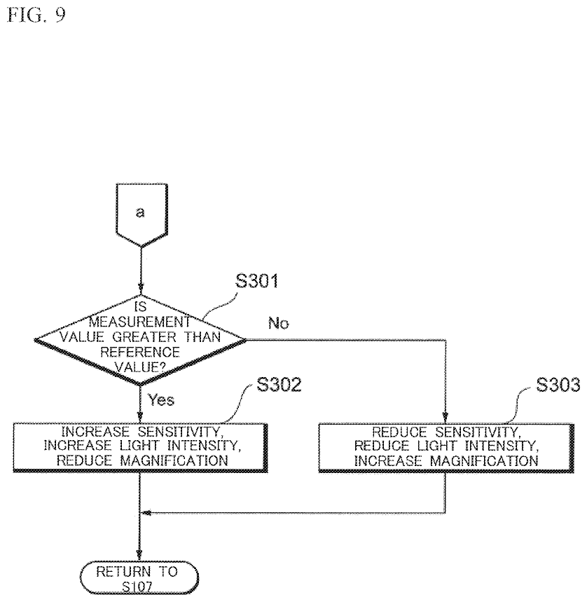

Next, a particle detection method according to the embodiment will be described with reference to FIG. 7, FIG. 8, and FIG. 9. As shown in FIG. 7, the particle detection method according to the embodiment includes: step S101 of activating the flow cytometer; step S102 of instructing the flow cytometer to perform analysis; step S103 of starting sending of a liquid into the flow cell 10; step S104 of acquiring information related to the flow velocity of the liquid flowing in the flow cell 10; step S105 of determining information related to the acquired flow velocity; step S106 of changing the liquid sending condition for sending the liquid into the flow cell 10; and step S107 of detecting light generated from a particle in the liquid irradiated with light in the flow cell 10.

In step S101 in FIG. 7, the flow cytometer according to the embodiment is activated. In step S102, the flow cytometer is instructed to start analysis of particles. In step S103, the sheath liquid sending unit 40A shown in FIG. 1 starts to send a predetermined amount of the sheath liquid to the flow cell 10, and the sample liquid sending unit 40B starts to send a predetermined amount of the sample liquid containing particles to the flow cell 10. In step S104, the light source 121A shown in FIG. 2 applies light to each particle flowing in the flow cell 10, and the flow velocity detector 161 detects modulated light, of scattered light generated from the particle, which is caused by the optical grating 151. The controller 300 shown in FIG. 1 calculates a measurement value of a flow velocity, as a value related to the flow velocity, based on the cycle of the modulated light. Note that step S104 may be started concurrently with step S103.

In step S105, the controller 300 calculates a measurement value of a flow velocity. In addition, the controller 300 reads out a reference value of a flow velocity from a memory or the storage device 351. Next, the controller 300 calculates a difference between the measurement value of the flow velocity of the particle and the reference value of the flow velocity. In step S106, when the difference between the measurement value of the flow velocity of the particle and the reference value of the flow velocity is greater than a predetermined value, the controller 300 changes the liquid sending condition for the liquid sending unit 40. When the difference between the measurement value of the flow velocity of the particle and the reference value of the flow velocity is smaller than the predetermined value, the controller 300 changes the detection condition for the detector 162. The controller 300 may change the light emission condition for the light source 121, or may change the magnification condition for the lens 137.

Specifically, in step S201 in FIG. 8, the controller 300 determines whether or not the difference between the measurement value of the flow velocity of the particle and the reference value of the flow velocity is greater than the predetermined value. When the determination result is that the difference is greater than the predetermined value, the controller 300 goes to step S202 and determines whether or not the measurement value of the flow velocity is greater than the reference value. When the determination result is that the difference is greater than the predetermined value and the measurement value is greater than the reference value, the controller 300 goes to step S203 and controls the liquid sending unit 40 to reduce the liquid feeding amount so as to approximate the difference to zero. Thereafter, the controller 300 returns to step S105 in FIG. 7. In steps S201 and S202 in FIG. 8, when the determination result is that the difference is greater than the predetermined value and the measurement value is smaller than the reference value, the controller 300 goes to step S204 and controls the liquid sending unit 40 to increase the liquid feeding amount so as to approximate the difference to zero. Thereafter, the controller 300 returns to step S105 in FIG. 7.

When the determination result in step S201 in FIG. 8 is that the difference between the measurement value of the flow velocity of the particle and the reference value of the flow velocity is not greater than the predetermined value, the controller 300 goes to step S301 in FIG. 9 and determines whether or not the measurement value of the flow velocity is greater than the reference value. When the determination result is that the difference is smaller than the predetermined value and the measurement value is greater than the reference value, the controller 300 goes to step S302 and changes the detection condition for the detector 162 so as to approximate the brightness of the fluorescence image to the appropriate value. The controller 300 may change the light emission condition for the light source 121, or may change the magnification condition for the lens 137. When the determination result in steps S201 and S301 is that the difference is smaller than the predetermined value and the measurement value is smaller than the reference value, the controller 300 goes to step S303 and changes the detection condition for the detector 162 so as to approximate the brightness of the fluorescence image to the appropriate value. The controller 300 may change the light emission condition for the light source 121, or may change the magnification condition for the lens 137.

When the detection condition has been changed in step S302 or step S303, the detector 162, in step S107, generates a fluorescence image of the particle. Analysis is completed when a predetermined amount of the sample liquid has been analyzed.

According to the flow cytometer and the particle detection method of the present embodiment, even when the flow velocity of the liquid flowing in the flow cell 10 varies while being affected by the ambient temperature, apparatus temperature, liquid temperature, liquid viscosity, change in the liquid level of the liquid in the supply chamber, etc., it is possible to reduce influence of variation in the flow velocity on the brightness of the fluorescence image. If the brightness of the fluorescence image varies even though the flow cytometer of the embodiment is used, it is possible to determine that the condition for fluorescent staining of particles has been varied.

In the flow cytometer, when captured particle images are analyzed, in order to inhibit reduction in analysis precision due to noise, images whose brightness values are smaller than a predetermined value are sometimes excluded from targets to be analyzed. Meanwhile, in the flow cytometer and the particle detection method according to the embodiment, since images of the desired brightness are obtained, the number of images to be excluded from the targets to be analyzed can be reduced. Thus, population of images to be analyzed is increased, whereby accurate analysis of particles can be performed.

The present invention has been described through the above embodiment, but it must not be understood that this invention is limited by the statements and the drawings constituting a part of this disclosure. From this disclosure, various alternative embodiments, examples, and operational technologies will become apparent to those skilled in the art. For example, the method for labeling a cell as a sample particle with a fluorescent dye is not limited to a method using a nucleic acid probe, and may be a method using a labeled reagent that uses antigen-antibody reaction or interaction between proteins other than antibodies. The sample particle may be a microorganism. In the above embodiment, when the flow velocity of a particle is measured, scattered light is used as reaction light generated from the particle. However, if the particle has an optical property of emitting a fluorescence, the fluorescence may be used as reaction light. Thus, it should be understood that the present invention includes various embodiments and the like not described herein.

The present invention can be suitably used in the field of analysis of a biological sample liquid containing particles such as cells and microorganisms, for example.

While the invention has been described in detail, the foregoing description is in all aspects illustrative and not restrictive. It will be understood that numerous other modifications and variations can be devised without departing from the scope of the invention.

What is claimed is:

1. A flow cytometer comprising:
a flow cell in which a liquid flows;
a liquid sending unit configured to send the liquid into the flow cell;
a controller configured to obtain information related to a flow velocity of the liquid flowing in the flow cell;
a light source configured to irradiate the liquid flowing in the flow cell with light; and
a detector configured to detect light generated from a particle in the liquid irradiated with light, wherein
the controller changes a liquid sending condition for the liquid sending unit, based on the obtained information related to the flow velocity.

2. The flow cytometer according to claim 1, wherein the controller further changes a detection condition for the detector, based on the obtained information related to the flow velocity.

3. The flow cytometer according to claim 2, wherein the controller selectively changes the liquid sending condition for the liquid sending unit or the detection condition for the detector, based on the obtained information related to the flow velocity.

4. The flow cytometer according to claim 2, wherein
the controller
changes the liquid sending condition for the liquid sending unit when a difference between a measurement value of the obtained flow velocity and a reference value of a flow velocity is greater than a predetermined value, and
changes the detection condition for the detector when the difference between the measurement value of the obtained flow velocity and the reference value of the flow velocity is smaller than the predetermined value.

5. The flow cytometer according to claim 4, wherein
the controller
causes the liquid sending unit to reduce an amount of the liquid to be sent into the flow cell, when the measurement value of the obtained flow velocity is greater than the reference value of the flow velocity and the difference is greater than the predetermined value, and
causes the liquid sending unit to increase the amount of the liquid to be sent into the flow cell, when the measurement value of the obtained flow velocity is smaller than the reference value of the flow velocity and the difference is greater than the predetermined value.

6. The flow cytometer according to claim 1, wherein the detector includes a photoelectric converter configured to perform photoelectric conversion of the light generated from the particle flowing in the flow cell.

7. The flow cytometer according to claim 1, wherein the controller further changes sensitivity of the detector, based on the obtained information related to the flow velocity.

8. The flow cytometer according to claim 1, further comprising a lens configured to condense the light generated from the particle in the liquid irradiated with light.

9. The flow cytometer according to claim 8, wherein the controller further changes magnification of an image, of the particle, formed by the lens, based on the obtained information related to the flow velocity.

10. The flow cytometer according to claim 1, wherein the controller further changes an intensity of light emitted from the light source, based on the obtained information related to the flow velocity.

11. The flow cytometer according to claim 1, wherein the detector captures an image of the particle flowing in the flow cell.

12. The flow cytometer according to claim 1, wherein the detector captures an image of the particle flowing in the flow cell, according to TDI (Time Delay Integration).

13. The flow cytometer according to claim 12, wherein the detector sets a scanning rate, based on the obtained information related to the flow velocity.

14. The flow cytometer according to claim 1, wherein the controller calculates the information related to the flow velocity, based on an optical property of the particle flowing in the flow cell.

15. A flow cytometer comprising:
a flow cell in which a liquid flows;
a liquid sending unit configured to send the liquid into the flow cell;
a controller configured to obtain information related to a flow velocity of the liquid flowing in the flow cell;
a light source configured to irradiate the liquid flowing in the flow cell with light; and
a detector configured to detect light generated from the particle in the liquid irradiated with light; wherein
the controller changes sensitivity of the detector, based on the obtained information related to the flow velocity.

16. A particle detection method comprising:
sending a liquid into a flow cell;
obtaining information related to a flow velocity of the liquid flowing in the flow cell;
changing a liquid sending condition for sending the liquid into the flow cell, based on the obtained information related to the flow velocity;
irradiating the liquid flowing in the flow cell with light; and
detecting light generated from a particle in the liquid irradiated with light.

17. The particle detection method according to claim 16, wherein a detection condition for detecting the light generated from the particle is changed based on the obtained information related to the flow velocity.

18. The particle detection method according to claim 17, wherein the liquid sending condition or the detection condition is selectively changed based on the obtained information related to the flow velocity.

19. The particle detection method according to claim 17, wherein
the liquid sending condition is changed when a difference between a measurement value of the obtained flow velocity and a reference value of a flow velocity is greater than a predetermined value, and
the detection condition is changed when the difference between the measurement value of the obtained flow velocity and the reference value of the flow velocity is smaller than the predetermined value.

20. The particle detection method according to claim 19, wherein
an amount of the liquid to be sent into the flow cell is reduced when the measurement value of the obtained flow velocity is greater than the reference value of the flow velocity and the difference is greater than the predetermined value; and
the amount of the liquid to be sent into the flow cell is increased when the measurement value of the obtained flow velocity is smaller than the reference value of the flow velocity and the difference is greater than the predetermined value.
